(19) United States
(12) Patent Application Publication
(10) Pub. No.: US 2004/0256889 A1
(43) Pub. Date: Dec. 23, 2004

(54) Foamed vehicle part and method of manufacturing

(76) Inventors: Horst Schonebeck, Gelnhausen (DE); Matthias Ludwig, Vechelde (DE); Marcus Lutz, Gifhorn (DE); Frank Niebuhr, Wilsche (DE)

Correspondence Address: CARLSON, GASKEY & OLDS, P.C., 400 WEST MAPLE ROAD, SUITE 350, BIRMINGHAM, MI, 48009, US

(21) Appl. No.: 10/874,589

(22) Filed: Jun. 23, 2004

(30) Foreign Application Priority Data
Jun. 23, 2003 (DE) 103 28 045.6

(51) Int. Cl. B62D 25/06

(52) U.S. Cl. 296/187.02; 264/46.4

(57) ABSTRACT

A method of manufacturing a vehicle body part embeds an insert piece into a foamed layer of the body part by holding the insert piece in a foaming tool using a magnetic force. The magnetic force holds the insert piece into position, eliminating the need for any additional holding structures in the foaming tool. A body part made by this method has improved visual quality, particularly at a transition area between the insert piece and a decorative part.

### REFERENCE TO RELATED APPLICATIONS

The present invention claims the benefit of German Patent Application No. 103 28 045.6, filed Jun. 23, 2003.

### TECHNICAL FIELD

The present invention relates to a vehicle body part and a method of manufacturing a vehicle body part, such as an add-on vehicle body part or a vehicle inner lining.

### BACKGROUND OF THE INVENTION

Add-on vehicle body parts form sections of an outer skin of the vehicle after assembly. Add-on body parts may include, for example, vehicle doors and flaps as well as vehicle roof modules and vehicle headliners. The body part may include a foamed layer deposited on a substrate that acts as the outer skin once the body part is attached to the vehicle.

There is an increasing demand for body parts that allow functional components to be secured thereon while allowing individual components to be exchanged and repositioned. Functional components of this kind are, for example, deposit areas, lockable consoles, screens, lamp systems, loudspeakers, shading systems and the like. To accommodate these types of functional components, inserts are embedded in the foamed layer. These inserts act as fastening elements to secure the functional components to the body part.

Currently known inserts have several problems, however. The inserts are difficult to position during the process of applying the foamed layer. Moreover, it is difficult to obtain a neat, visually-pleasing transition between the insert and any large-surface decorative part that is also usually provided on the body part (e.g., plastic sheet, textile fabric or sheet metal foil). For this reason, the decorative part is normally in the form of an unbroken sheet, covering an area where the insert is to be located. The decorative part is then later punctured after the body part is substantially complete to accommodate any components to be attached to the insert (e.g., to screw a fastening screw into the insert).

There is a desire for a method and system that allows a vehicle body part to have fastening elements that are easily positioned during manufacturing of the body part and that provides a flexible, visually pleasing way to attach functional components.

### SUMMARY OF THE INVENTION

The invention is directed to a method for positioning inserts, which serve as fastening elements, into a foaming tool in a simple and reliable manner to form a vehicle body part. The invention is also directed to a vehicle roof module and a vehicle headliner having a fastening system for add-on components that is suitable to be used for any desired purpose.

The method in accordance with one embodiment of the invention includes securing an insert piece, which serves as a fastening member for an external add-on component, via a magnet integrated in a foaming tool. The method also includes introducing a liquid plastic material into the foaming tool, closing the foaming tool, and foaming the plastic material to form a foamed layer. Foaming the plastic material embeds the insert piece into the foamed layer.

A large-surface decorative part may be placed inside the foaming tool. The decorative part has a hole at a position of the insert piece. The insert piece is then firmly positioned in place on the decorative part by the magnet. The insert piece presses the decorative part against the inner wall of the foaming tool in the vicinity of the hole so that the insert piece seals the hole against leakage of the foamed plastic material through the decorative part.

The invention further relates to a vehicle roof module and a vehicle headliner that are manufactured by the method described above.

### BRIEF DESCRIPTION OF THE DRAWINGS

Further features and advantages of the invention will be apparent from the following description and from the accompanying drawings to which reference is made and in which:

FIG. 1 is a top view of an outer side of a vehicle headliner manufactured according to a method of one embodiment of the invention;

FIG. 2 is a sectional view of the headliner of FIG. 1 taken along the line II-II;

FIG. 3 is an enlarged sectional view of the headliner in the area marked by X in FIG. 2;

FIGS. 4 through 7 are sectional views of the headliner according to one embodiment of the invention with various add-on components attached thereon;

FIG. 8 is a sectional view of a foaming tool for carrying out the method according to one embodiment of the invention; and

FIG. 9 is an enlarged sectional view of a locating bushing in the foaming tool to be employed in the method according to one embodiment of the invention.

### DETAILED DESCRIPTION OF THE EMBODIMENTS

The invention is generally directed to a method for positioning inserts, which serve as fastening elements, into a foaming tool in a simple and reliable manner to form a vehicle body part. The invention is also directed to a vehicle roof module and a vehicle headliner having a fastening system for any desired add-on components.

The inserts are positioned and attached to the body part by placing an insert piece, which will serve as a fastening member for external add-on components, using a magnet integrated in a foaming tool. A liquid plastic material is introduced into the foaming tool and the foaming tool is closed. The plastic material is then foamed to form a foamed layer, embedding the insert piece into the plastic material.

In one possible method of the invention, an inner side of the foaming tool may be designed to be very flat and non-stepped. The flat results in high surface quality of the body part produced by the foaming tool. Moreover, by using magnetic force to hold the insert piece securely in the foaming tool, the invention can eliminate complicated partial vacuum systems, which tend to pull the foam toward a suction channel, for holding the insert piece. This further improves the surface quality and structural quality of the body part.

In one embodiment, a large-surface decorative part made of, for example, textile fabric, plastic sheet, or aluminum or iron sheet metal, is placed inside the foaming tool before the insert piece is secured inside the foaming tool by the magnet. The decorative part has a hole at a position of the insert piece. The insert piece is then firmly positioned in place on the decorative part by the magnet. The magnet itself is disposed outside a foaming cavity of the foaming tool. The insert piece presses the decorative part against the inner wall of the foaming tool in a vicinity of the hole, thereby forming a seal to prevent any of the foamed plastic material from leaking through the hole both before and during foaming. The insert piece preferably projects through the hole into an opening at the inner side of the foaming tool, thereby positioning the insert piece in a lateral direction. The magnet positions and holds the insert piece in an axial direction.

The magnet itself may be, for example, a ring magnet that surrounds an opening into which the insert piece projects in sections. The ring magnet ensures a uniform attraction force on the insert piece and prevents the insert piece from tilting when the foamed layer is applied.

In one embodiment, the insert piece has a flange and a pin projection, such as a headless pin projection, protruding from the flange. If the insert piece uses, for example, a threaded bushing, the magnet additionally has a corresponding projecting pin.

When particularly high pressures are involved in the foaming process, a certain sealing distance should be provided between the insert piece and the area of the decorative part that contacts the insert piece. This distance prevents the foamed plastic material from reaching the hole in the decorative part. No separate sealant is needed between the insert piece and the decorative part. If the insert piece is cylindrical, the part of the flange on the insert piece that directly contacts a rear side of the decorative part should have a diameter that is 1.5 to 3 times larger than the diameter of the hole to ensure proper sealing. This diameter substantially corresponds to a diameter of the pin projection.

The invention is particularly suitable for roof modules, hardtops, and headliners as well as other outer and inner lining parts, paneling parts and structural components of motor vehicles. In one embodiment, the foamed layer can be produced by, for example, structural reaction injection molding (S-RIM) or long fiber injection (LFI) methods.

In one embodiment, the insert piece includes an internal thread or an external thread. An elongated profiled part may also be employed as the insert piece. Using an elongated profiled part as the insert piece allows a given add-on component to be secured at any desired point along the profiled part, similar to a rail system. A profile in the profiled part is preferably open toward an outer side of the decorative part.

In accordance with one embodiment, when the body part is a headliner, a plurality of spaced profiled parts is distributed over the headliner so that add-on components may be attached at any desired place.

The invention further relates to a vehicle roof module and a vehicle headliner that are manufactured by the method in accordance with the invention.

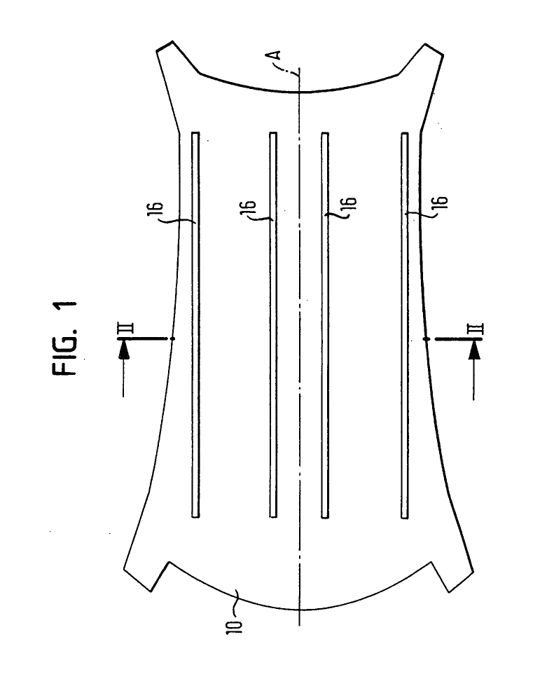

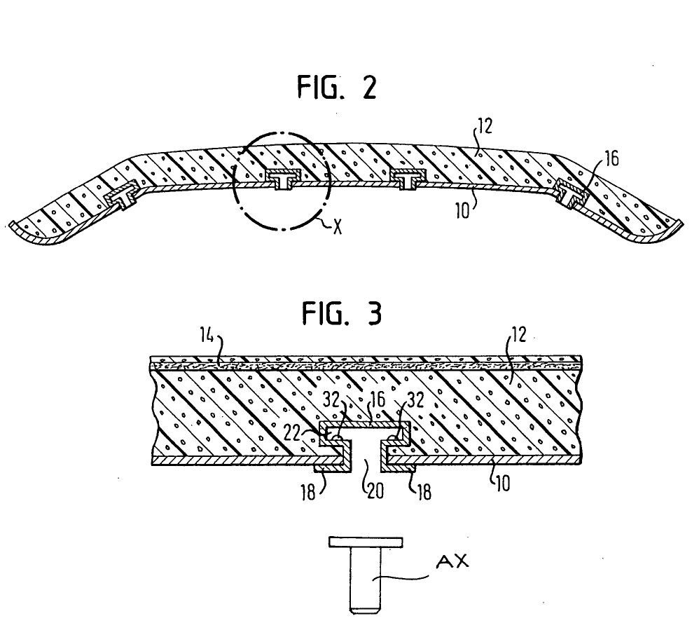

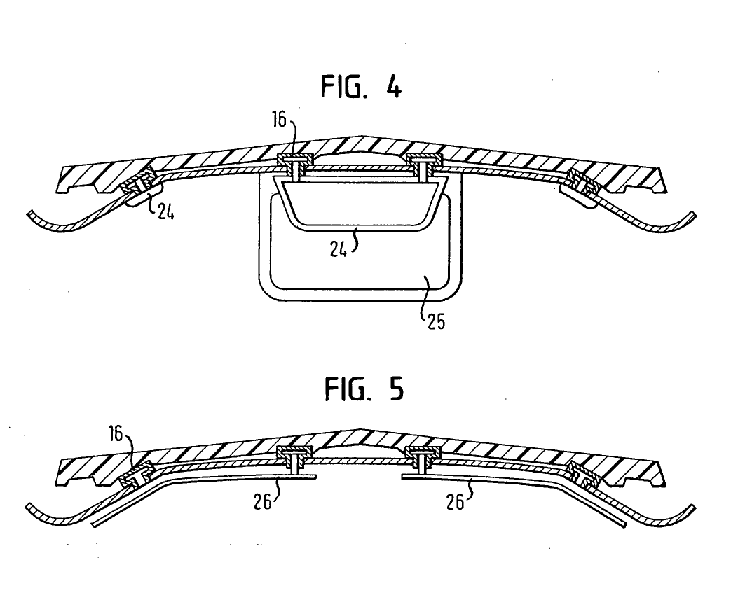

Referring to the figures, FIG. 1 illustrates a vehicle headliner manufactured by a method in accordance with one embodiment of the invention, which will be explained in greater detail below. An exterior (visible) side of the headliner is formed by a decorative part 10, such as a textile fabric, a sheet of any desired material, or a metal or plastic foil. As shown in FIGS. 2 and 3, the decorative part 10 is provided with a foamed layer 12 made of a foamed material, such as polyurethane, on its rear side. A reinforcing inset 14, such as a fiber mat or the like, may be embedded in the foamed layer 12.

A plurality of parallel insert pieces in the form of open hollow profiles 16 may extend parallel to a longitudinal axis A of the vehicle. The profiles 16 may have an Ω-shaped cross-sectional form, as shown in FIG. 3. The profile 16 has a pair of flat lateral flanges 18 that engage the exterior side of the decorative part 10. The profile 16 further has a narrow through-opening 20 and a widened undercut portion 22.

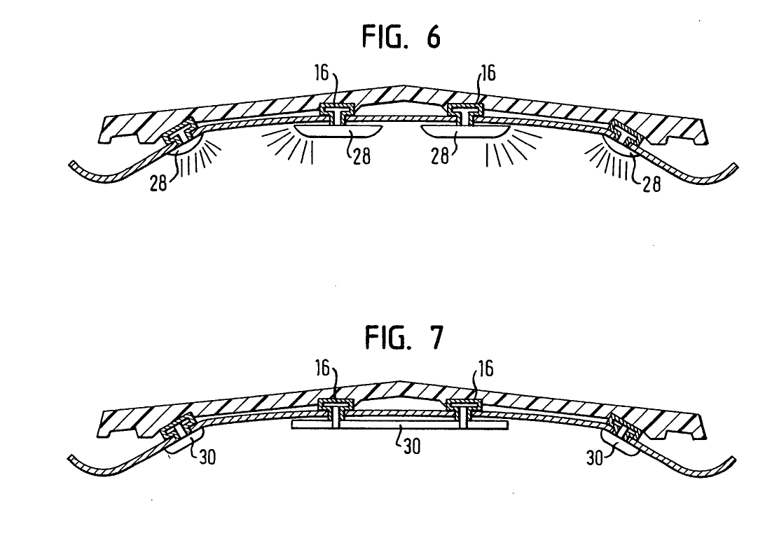

The profiles 16 acting as the insert pieces make it possible to attach add-on components to the body part. Possible add-on components include, for example, longitudinally adjustable and exchangeable consoles 24 (FIG. 4) for linking other add-on components to the profiles 16, screens 25 (FIG. 4), roller blinds or sunshade systems 26 (FIG. 5), loudspeakers 28 (FIG. 6) or light sources 30 (FIG. 7). As noted above, the shape of the profiles 16 allow the add-on components to be attached from the interior of the vehicle at any desired location.

To ensure that electricity can be supplied to a given add-on component at any desired location, current-carrying contacts 32 may be arranged within the undercut portion 22 along the length of the profile 16 (FIG. 3).

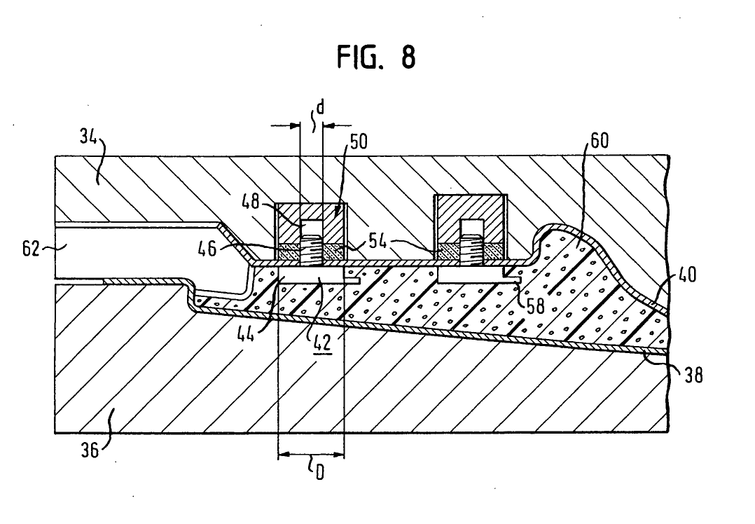

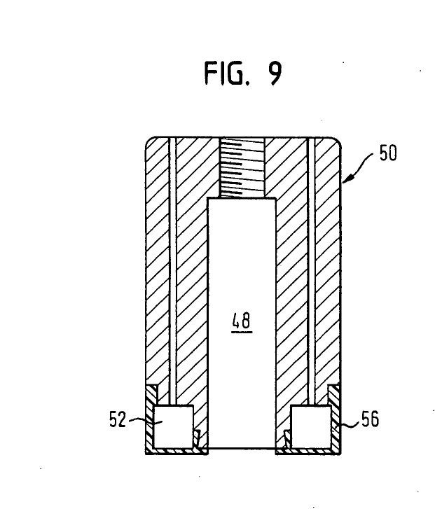

FIGS. 8 and 9 illustrate one embodiment of a foaming tool that can be used to manufacture the body part described above as well as other add-on vehicle body parts, such as roof modules, doors and flaps. The foaming tool comprises an upper part 34 and a lower part 36. When the upper and lower parts 34, 36 of the foaming tool are moved toward each other, they form a foaming cavity between them that can be filled with, for example, foamed polyurethane.

The example in FIG. 8 shows a roof module formed by the foaming process. In this example, a deep-drawn thermoplastic sheet 38 that has been dyed throughout or an aluminum sheet is placed inside the lower part 36 of the foaming tool to engage an inner side of the lower part 36. The entire surface of the sheet 38 engages with the lower part 36. A sheet-like decorative part 40, similar to the decorative part 10 described above, is secured to an inner side of the upper part 34 of the foaming mold.

Next, substantially cylindrical insert pieces 42 are attached to the upper part 34 of the foaming mold from an inner side of the decorative part 40. A decoration support 62 surrounding a border area of the upper part 34 clamps the decorative part 40 to the foaming mold by the edges of the decorative part 40. The cylindrical insert piece 42 has a flange 44 that engages an inner side of the decorative part 40. A threaded bolt 46 protrudes from this flange 44 through a prefabricated hole in the decorative part 40 and into an opening 48 in a holder bushing 50 in the upper part 34 of the foaming mold. The diameter of the opening 48, the diameter of the threaded bolt 46, and the diameter d of the hole in the decorative part 40 are substantially the same.

FIG. 9 shows the holder bushing 50 in more detail. An accommodation space 52 is adjacent to the opening 48 at its lower end face to accommodate a ring magnet 54 (FIG. 8). The accommodation space 52 is closed by a plastic ring 56.

As also shown in FIG. 8, lateral extensions 58 are included in the region of the flange 44 and are spaced apart from the decorative part 40. The lateral extensions enhance the anchoring of the cylindrical insert piece 42 in a foamed layer 60, which is similar to the foamed layer 12 described above.

The diameter D of the surface of the flange 44, which contacts the decorative part 40, is approximately 1.5 to 3 times as large as the diameter d of the hole in the decorative part 40 to ensure secure sealing and prevent leakage of the plastic material forming the foamed layer 60 through the hole.

In one embodiment, the cylindrical insert piece 42 is made of metal or has a metal inlay to ensure that the cylindrical insert piece 42 will be attracted to the ring magnet 54, thereby pressing the flange 44 firmly against the decorative part 40. The decorative part 40 is in turn pressed firmly against the inner side of the upper part 34 of the foaming mold. The cylindrical insert piece 42 is thus firmly mounted in position in the upper part 34 of the foaming mold in both the axial and radial directions.

Once the cylindrical insert piece 42 is firmly in position, a liquid material, such as polyurethane, is applied onto the rear side of the sheet 38. If desired, reinforcing glass fibers may be added to the liquid material by, for example, the LFI method.

The upper and lower parts 34 and 36 of the foaming mold are then moved toward each other. The liquid material reacts and foams, filling the foaming cavity between the upper and lower parts 34, 36 to connect the decorative part 40 with the sheet 38 via the foamed layer 60. The cylindrical insert piece 42 is thus firmly embedded in the foamed layer 60.

The cylindrical insert piece 42 presses against the decorative part 40 so firmly that no foamed material seeps between the cylindrical insert piece 42 and the decorative part 40 or escapes from the hole in the decorative part 40. This tightness is attained without having to apply any elastic sealants on the inner side of the upper part 34. Thus, the resulting body part does not have any seals that would be subject to constant wear and deterioration.

Note that the cylindrical insert piece 42 itself does not need to be made of metal in order to be positioned by the magnet 54. In the insert piece configuration shown in FIG. 3, for instance, an auxiliary fastening element AX may be temporarily placed in the insert piece (such as in the hollow profile 16) solely for achieving the fastening. The auxiliary fastening element AX may be, for example, a swiveling tenon block having a pin-line extension placed into the insert piece to project into the opening 48.

It should be appreciated that in the example shown in FIGS. 1 through 3, it is possible to eliminate the flanges 18, allowing the widened undercut portion 22 of the hollow profile 16 to contact the inner side of the decorative part 10. It is further not necessary for the decorative parts 10, 40 to be formed as single layers. Instead, the decorative parts 10, 40 may be in the form of multi-layer sheets having a thickness of a few millimeters. The decorative part 10, 40 may, for example, have a reinforcing layer similar to the reinforcing inset 14 shown in FIG. 3 provided on its rear side. Also note that for the embodiment shown in FIGS. 1 through 3, any holes in the foaming tool for accommodating the profiles 16 (i.e., the insert pieces) take the shape of long slots. These holes would be formed before the decorative part 10 is introduced into the foaming tool.

It should be understood that various alternatives to the embodiments of the invention described herein may be employed in practicing the invention. It is intended that the following claims define the scope of the invention and that the method and apparatus within the scope of these claims and their equivalents be covered thereby.

1. A method of manufacturing a vehicle body part, comprising:
securing an insert piece that serves as a fastening member for an add-on component into a foaming tool, wherein the securing step is conducted by magnetic force;
introducing a liquid plastic material into the foaming tool;
closing the foaming tool; and
foaming the liquid plastic material to form a foamed layer, wherein the insert piece is embedded into the foamed layer.

2. The method according to claim 1, further comprising placing a decorative part inside the foaming tool between the insert piece and an inner side of the foaming tool, wherein the decorative part has a hole at a location of the insert piece.

3. The method according to claim 2, wherein the placing step is conducted before the securing step, and wherein the securing step firmly positions the insert piece in place on the decorative part via the magnetic force, wherein the magnetic force is applied from an area outside of the decorative part.

4. The method according to claim 3, wherein the securing step causes the insert piece to press the decorative part against the inner side of the foaming tool to prevent any portion of the foamed layer from passing through the hole in the decorative part to a front side of the decorative part.

5. The method according to claim 2, wherein at least a portion of the insert piece projects through the hole in the decorative part into an opening at the inner side of the foaming tool.

6. The method according to claim 5, further comprising the step of laterally positioning the insert piece using the opening in the inner side of the foaming tool.

7. The method according to claim 1, wherein the magnet used in the securing step is a ring magnet.

8. The method according to claim 7, wherein the ring magnet surrounds an opening in an inner side of the foaming tool.

9. A roof module for a vehicle, comprising:
a sheet that is dyed throughout to form an outer skin of the roof module;
a decorative part that forms at least a portion of a headliner in the roof module;
an insert piece disposed between the sheet and the decorative part, wherein the insert piece serves as a fastening member for an add-on component, and wherein the insert piece was placed into a foaming tool and secured in the foaming tool by magnetic force;
a foamed layer, wherein the insert piece is embedded in the foamed layer and wherein the foamed layer connects the sheet to the decorative part,
wherein the insert piece is accessible from an outer side of the decorative part.

10. The roof module of claim 9, wherein the insert piece comprises a plurality of elongated profiles distributed over the roof module and spaced apart from each other.

11. The roof module of claim 10, further comprising at least one current-carrying contact extending along a length of at least one of said plurality of profiles to supply power.

12. The roof module of claim 9, further comprising at least one current-carrying contact in the insert piece.

13. The roof module of claim 9, wherein the insert piece includes a flange and a projection protruding from the flange.

14. The roof module of claim 13, wherein the decorative part has a hole at a location of the insert piece.

15. The roof module of claim 14, wherein a portion of the flange on the insert piece contacts a rear side of the decorative part, and wherein the portion of the flange has a diameter that is larger than a diameter of the hole in the decorative part.

16. The roof module of claim 9, wherein the insert piece has an opening accessible from an outer side of the decorative part.

17. The roof module of claim 9, wherein the insert piece has an elongated profile.

18. The roof module of claim 17, wherein the elongated profile is open toward an outer side of the decorative part.

19. The roof module of claim 9, further comprising a console that is adjustable along and securable to the insert piece, wherein the console is adapted to accommodate the add-on component to be attached to the insert piece.

20. The roof module of claim 9, wherein the add-on component is at least one selected from the group consisting of a screen, a sunshade system, a loudspeaker and a light source.

21. A headliner for a vehicle roof, comprising:
a decorative part;
an insert piece disposed on the decorative part, wherein the insert piece serves as a fastening member for an add-on component, wherein the insert piece was placed into a foaming tool and secured in the foaming tool by magnetic force and wherein the insert piece is accessible from an outer side of the decorative part; and
a foamed layer, wherein the insert piece is embedded in the foamed layer.

22. The headliner of claim 21, wherein the insert piece comprises a plurality of elongated profiles distributed over the headliner and spaced apart from each other.

23. The headliner of claim 21, further comprising at least one current-carrying contact in the insert piece.

24. The headliner of claim 21, wherein the insert piece includes a flange and a projection protruding from the flange.

25. The headliner of claim 21, wherein the decorative part has a hole at a location of the insert piece, wherein a portion of the flange on the insert piece contacts a rear side of the decorative part, and wherein the portion of the flange has a diameter that is larger than a diameter of the hole in the decorative part.
